(19) United States
(12) Patent Application Publication
(10) Pub. No.: US 2018/0207041 A1
(43) Pub. Date: Jul. 26, 2018

(54) LEG LIFTING STRAP

(71) Applicants: MATTHEW J. CAMPBELL, Hurst, TX (US); VICTORIA M. CAMPBELL, Hurst, TX (US)

(72) Inventors: MATTHEW J. CAMPBELL, Hurst, TX (US); VICTORIA M. CAMPBELL, Hurst, TX (US)

(21) Appl. No.: 15/415,588

(22) Filed: Jan. 25, 2017

(51) Int. Cl. A61G 7/10

(52) U.S. Cl. CPC A61G 7/1051; A61G 7/1023

(57) ABSTRACT

A device and method for the lifting and maneuvering of a leg with limited mobility is described. The device includes a lower strap and an upper strap. The lower strap includes at least one first fastener and is configured to wrap around the leg below the knee. The upper strap is coupled to the lower strap and includes at least one second fastener. The upper strap is configured to wrap over the leg above the knee. The lower strap and the upper strap are each configured to provide a handle for lifting the leg. The tension or tightness is adjustable with each strap. Once located along the leg, the user may grasp any portion to maneuver the leg as necessary.

### BACKGROUND

### 1. Field of the Invention

The present application relates to a device used for the lifting of a leg, and more particularly to a fully adjustable device that wraps around the leg area about the knee to permit a user to pull on and adjust the location of the leg.

### 2. Description of Related Art

Many individuals suffer from medical conditions that have greatly limited, if not eliminated, mobility in their legs. Such individuals are often confined to sitting and laying positions. It is common for a wheelchair or other sitting apparatus to be used to assist in mobilizing the individuals and permitting normal functions. Due to limited or no mobility in the legs, it is necessary to manually lift the legs to reposition them. This is necessary when sitting for a while, transitioning between sitting positions, transitioning between sitting devices, and so forth. For example, when moving between a shower or toilet and a wheelchair, the legs need to be lifted and moved. However it becomes difficult to grab hold of the legs at times.

Although strides have been made to increase the mobility and function of individuals with limited or no mobility in their legs, considerable shortcomings remain. A device is needed to allow the individual or a caregiver to grasp and maneuver the legs as needed.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a front perspective view of a leg lifting strap about a leg according to an embodiment of the present application.

FIG. 2 is a side view of the leg lifting strap of FIG. 1 about the leg.

FIG. 3 is a side view of the leg lifting strap of FIG. 1.

FIG. 4 is a rear view of the leg lifting strap of FIG. 3 in an open position.

FIG. 5 is a top view of the leg lifting strap of FIG. 4.

FIG. 6 is a front view of the leg lifting strap of FIG. 4.

While the device and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The device and method in accordance with the present application overcomes one or more of the above-discussed problems commonly associated with the difficulties of mobility impaired individuals. In particular, the device is configured to wrap around an area of the leg adjacent to the knee and provide a plurality of locations for the individual to grasp in order to lift and maneuver the leg. The device is fully adjustable and is designed to create as minimal of an obstruction as possible. These and other unique features of the device are discussed below and illustrated in the accompanying drawings.

The device and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The device and method of the present application is illustrated in the associated drawings. The device includes a lower strap and an upper strap. The lower strap includes at least one first fastener and is configured to wrap around the leg below the knee. The upper strap is coupled to the lower strap and includes at least one second fastener. The upper strap is configured to wrap over the leg above the knee. The lower strap and the upper strap are each configured to provide a handle for lifting the leg. Additional features and functions of the device are illustrated and discussed below.

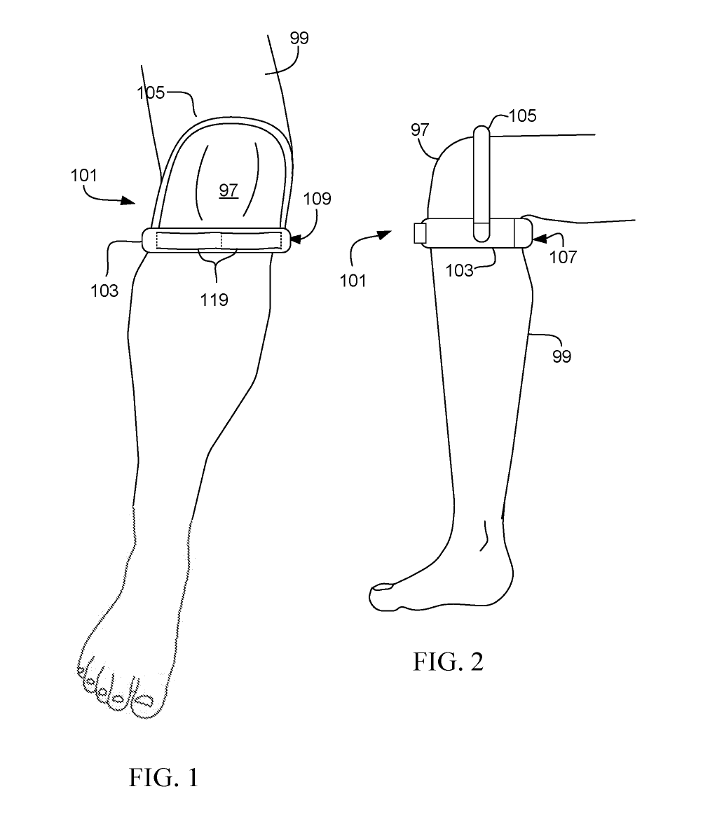

Referring now to the drawings wherein like reference characters identify corresponding or similar elements in form and function throughout the several views. FIGS. 1 and 2 illustrate assorted views of the leg lifting strap device 101 secured around a leg 99 of an individual. The leg 99 is bent about the knee 97 to an approximate angle of 90 degrees. This is shown in this alignment because it roughly represents the approximate position of leg 99 when seated. Device 101 is operable with the leg aligned in any angle.

As seen in the Figures, device 101 includes lower strap 103 and an upper strap 105. Each strap has at least one fastener allowing the strap to selectively wrap around a portion of leg 99 and fasten to itself. In particular, lower strap 103 is an elongated, general rectangular shaped material, having a first fastener 107. Fastener 107 couples opposing ends of lower strap 103 together. Lower strap 103 wraps fully around leg 99. Upper strap is composed of one or more sections, each section separately coupled to lower strap 103. Upper strap 105 is configured to extend from lower strap 103 and wrap over a portion of leg 99 above knee 97.

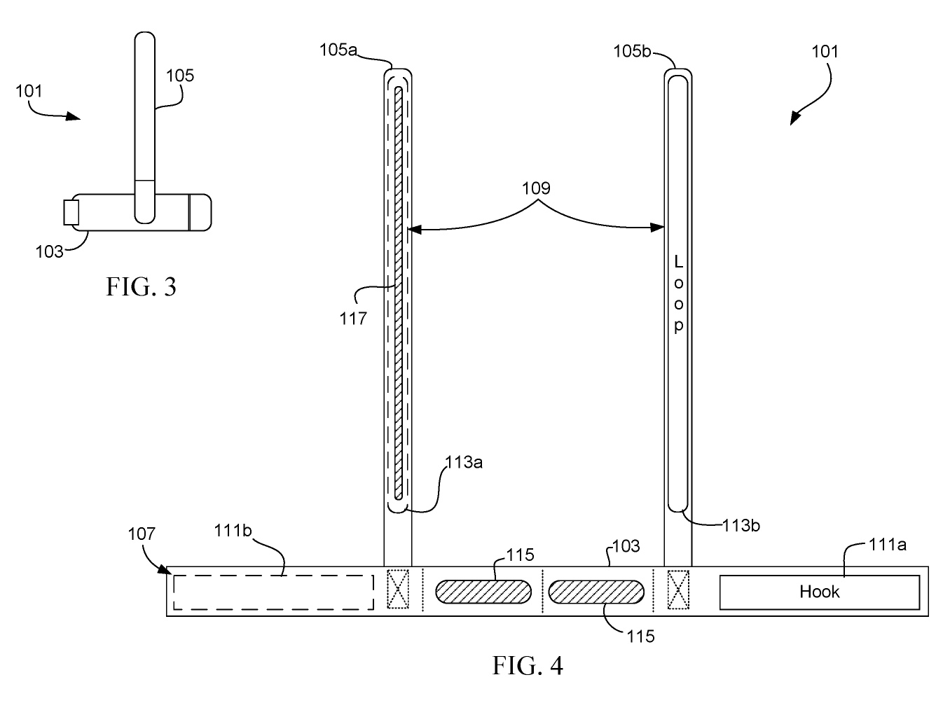

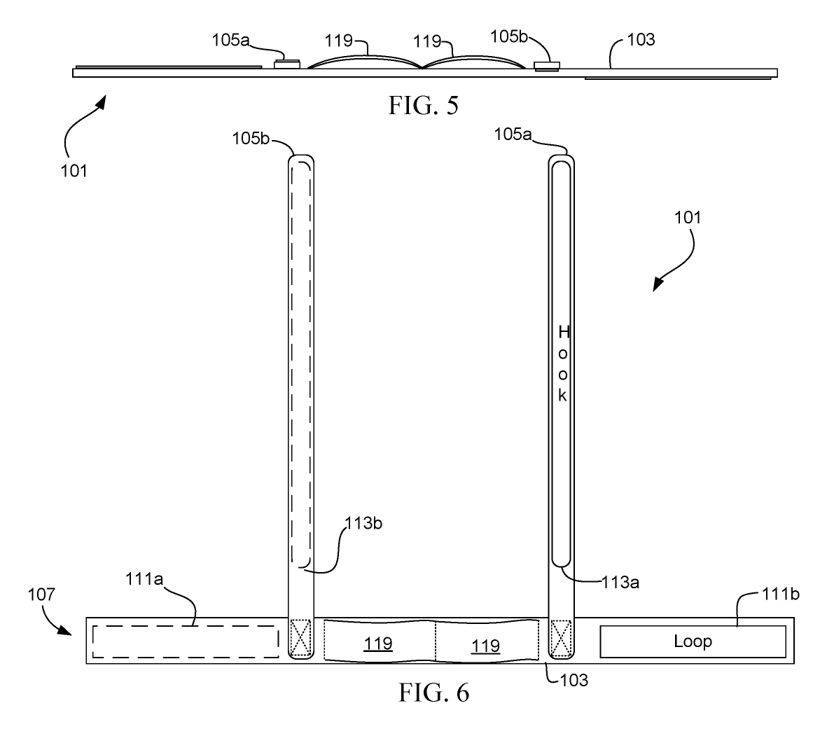

Referring now also to FIGS. 3-6 in the drawings, assorted views of device 101 are illustrated. FIG. 3 shows a side view of device 101. FIGS. 4 and 6 illustrate a rear view and a front view of device 101, respectively. FIG. 5 is a top view of device 101 as seen from FIG. 4. These figures are useful in seeing the individual details of device 101.

Device 101 is configured to provide a user with the ability to fully adjust the tension/tightness experienced around the leg 99 from each fastener. Adjustment of fastener 109 may affect the location of strap 103 relative to the knee 97. Adjustment of fastener 107 affects the diameter of strap 103. Fasteners 107 and 109 are fully adjustable in and of themselves. When secured, each strap acts as a handle for the user to grasp so as to maneuver/lifting the leg.

For purposes herein, fasteners 107 and 109 are described as hook and loop fasteners, but it is understood that other types of fasteners are possible. For example, buttons, zippers, snaps, clips, and the like may be used. In this application, fasteners 107 and 109 are configured to couple as each strap overlaps itself. Other types of fasteners work differently and may not necessitate overlapping to couple. It is important only that each strap 103 and 105 be adjustable around leg 99.

First fastener 107 (of strap 103) includes hook portion 111a and loop portion 111b. Hook portion 111a and loop portion 111b are coupled to opposing ends of strap 103 and on opposite sides to allow them to mate when overlapped. A similar operation is had in relation to upper strap 105. Upper strap 105 is separated into two sections, namely sections 105a and 105b. Each section has an end coupled to strap 103, and an opposite end distal strap 103. Sections 105a and 105b are typically coupled to the same side of strap 103 so as to avoid rubbing uncomfortably along leg 99. Fasteners 113a and 113b operate similarly to that of fasteners 111a and 111b respectively, themselves being hook and loop fasteners. The hook portion 113a is in communication with section 105a while loop portion 113b is in communication with section 105b. Portions 113a and 113b are coupled to opposing sides of each respective section 105a and 105b to allow them to mate upon overlapping above the knee 97. It is understood that fasteners 107 may be a different type of fastener compared to fastener 109 in some embodiments.

Padding may optionally be included within device 101. As seen in particular to FIG. 4 only, padding 115 may be located on strap 103 and padding 117 may be located on strap 105. Padding is useful to increase comfort to the user when wearing it. As seen, padding 115 is located the side opposite hook portion 113a because that side is the side that contacts leg 99. Padding is not restricted to the sides or portions of device 101 as shown. It may be located in any spot. Additionally, padding may be useful as a means of increasing the comfort to the user when grasped by the hand.

As a means of increasing the ability to grasp device 101, device 101 may further include one or more handles 119. Handles 119 are selectively coupled to strap 103 and/or strap 105. Handles 119 may be configured to be adjustable in length themselves and can be removable.

In operation, a user obtains device 101 and secures the lower strap around the leg below the knee while securing the upper strap over the leg above the knee. At the appropriate time the user grasps a portion of the lower strap and/or the upper strap so as to elevate and move the leg as necessary. Each strap may be adjusted in tightness to make it comfortable and easy to use. The user may grasp the handle, the upper strap, and/or the lower strap.

The current application has many advantages over the prior art including at least the following: (1) a comfortable and functional device for maneuvering legs with limited mobility; (2) simple and quick to operate; (3) optional padding and handles; and (4) collapsible and compact storage.

The particular embodiments disclosed above are illustrative only and are not intended to be exhaustive or to limit the invention to the precise form disclosed, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A leg lifting strap for a leg, comprising:
a lower strap having at least one first fastener, the lower strap configured to wrap around the leg below a knee; and
an upper strap coupled to the lower strap and configured to have a second fastener, the upper strap configured to wrap over the leg above the knee;
wherein the lower strap and the upper strap are each configured to provide a handle for lifting the leg.

2. The strap of claim 1, wherein the lower strap is adjustable such that the diameter of the lower strap can be adjusted.

3. The strap of claim 1, wherein the upper strap is adjustable such that the height of the upper strap can change.

4. The strap of claim 1, wherein the first fastener is a hook and loop fastener.

5. The strap of claim 1, wherein the second fastener is a hook and loop fastener.

6. The strap of claim 1, wherein the lower strap includes padding to increase the comfort of the lower strap against the leg.

7. The strap of claim 1, wherein the upper strap includes padding.

8. The strap of claim 1, wherein the upper strap is coupled to the lower strap at a plurality of locations.

9. The strap of claim 8, wherein the members of the upper strap overlap each other.

10. The strap of claim 1, wherein the lower strap includes one or more loop handles.

11. A method of maneuvering a leg, comprising:
obtaining the leg lifting strap of claim 1;
securing the lower strap around the leg below the knee;
securing the upper strap over the leg above the knee;
grasping at least one or the lower strap and the upper strap so as to elevate and move the leg.

12. The method of claim 11, wherein the lower strap is adjustable such that the diameter of the lower strap can be adjusted.

13. The method of claim 11, wherein the upper strap is adjustable such that the height of the upper strap can change.

14. The method of claim 11, wherein the first fastener is a hook and loop fastener.

15. The method of claim 11, wherein the second fastener is a hook and loop fastener.

16. The method of claim 11, wherein the lower strap includes padding to increase the comfort of the lower strap against the leg.

17. The method of claim 11, wherein the upper strap includes padding.

18. The method of claim 11, wherein the upper strap is coupled to the lower strap at a plurality of locations.

19. The method of claim 18, wherein the members of the upper strap overlap each other.

20. The method of claim 11, wherein the lower strap includes one or more loop handles.
